(19) United States
(12) Patent Application Publication
(10) Pub. No.: US 2018/0143553 A1
(43) Pub. Date: May 24, 2018

(54) TONER, DEVELOPER CONTAINER, IMAGE FORMING UNIT, AND IMAGE FORMING APPARATUS

(71) Applicant: Oki Data Corporation, Tokyo (JP)

(72) Inventor: Hideharu KUWABARA, Tokyo (JP)

(21) Appl. No.: 15/814,505

(22) Filed: Nov. 16, 2017

(30) Foreign Application Priority Data
Nov. 24, 2016 (JP) 2016-227700

(51) Int. Cl. G03G 9/09; G03G 9/087

(52) U.S. Cl. CPC G03G 9/0926; G03G 2221/18; G03G 9/08755

(57) ABSTRACT

A toner includes: a binder resin; a release agent; and a brilliant pigment including aluminum. A content of aluminum in the toner is greater than or equal to 6.7% and less than or equal to 17.2%, the content of aluminum being measured by an energy dispersive X-ray fluorescence spectrometer.

### BACKGROUND OF THE INVENTION

### 1. Field of the Invention

The present invention relates to a toner, a developer container, an image forming unit, and an image forming apparatus.

### 2. Description of the Related Art

Conventionally, an electrophotographic image forming apparatus, such as a printer, copier, facsimile machine, or multi-function peripheral, includes an image forming unit including a photosensitive drum, a charging roller, a developing unit, and the like. The image forming apparatus performs printing as follows. A surface of the photosensitive drum is uniformly charged by the charging roller and exposed by a light emitting diode (LED) head, so that an electrostatic latent image is formed on the surface. The electrostatic latent image is developed with toner supplied from a toner cartridge as a developer container, so that a toner image is formed on the surface. The toner image is transferred onto a sheet of paper as a medium by a transfer roller and then fixed to the sheet by a fixing unit, so that an image is formed on the sheet.

Japanese Patent Application Publication No. 2016-138921 discloses a printer that uses a brilliant toner containing a brilliant pigment to form an image having metallic luster, such as gold or silver, or a brilliant image.

However, depending on the content of the brilliant pigment in the brilliant toner, the printer cannot form images with high brilliance and thus cannot produce high quality images.

### SUMMARY OF THE INVENTION

An aspect of the present invention is intended to provide a toner, a developer container, an image forming unit, and an image forming apparatus capable of producing high quality brilliant images.

According to an aspect of the present invention, there is provided a toner including: a binder resin; a release agent; and a brilliant pigment including aluminum, wherein a content of aluminum in the toner is greater than or equal to 6.7% and less than or equal to 17.2%, the content of aluminum being measured by an energy dispersive X-ray fluorescence spectrometer.

### BRIEF DESCRIPTION OF THE DRAWINGS

In the attached drawings:

FIG. 1 is a schematic diagram of a printer according to an embodiment of the present invention;

FIG. 2 is a sectional view of an image forming unit according to the embodiment of the present invention;

FIG. 3 is a perspective view of a toner cartridge according to the embodiment of the present invention;

FIG. 4 is a diagram for explaining a method of measuring the brilliance of a solid image in the embodiment of the present invention;

FIGS. 5 to 7 are diagrams each for explaining an inclusion degree of a pigment in the embodiment of the present invention; and

FIG. 8 is a table showing evaluation results of toners in the embodiment of the present invention.

### DETAILED DESCRIPTION OF THE INVENTION

An embodiment of the present invention will now be described with reference to the attached drawings. In this embodiment, a printer as an image forming apparatus will be described.

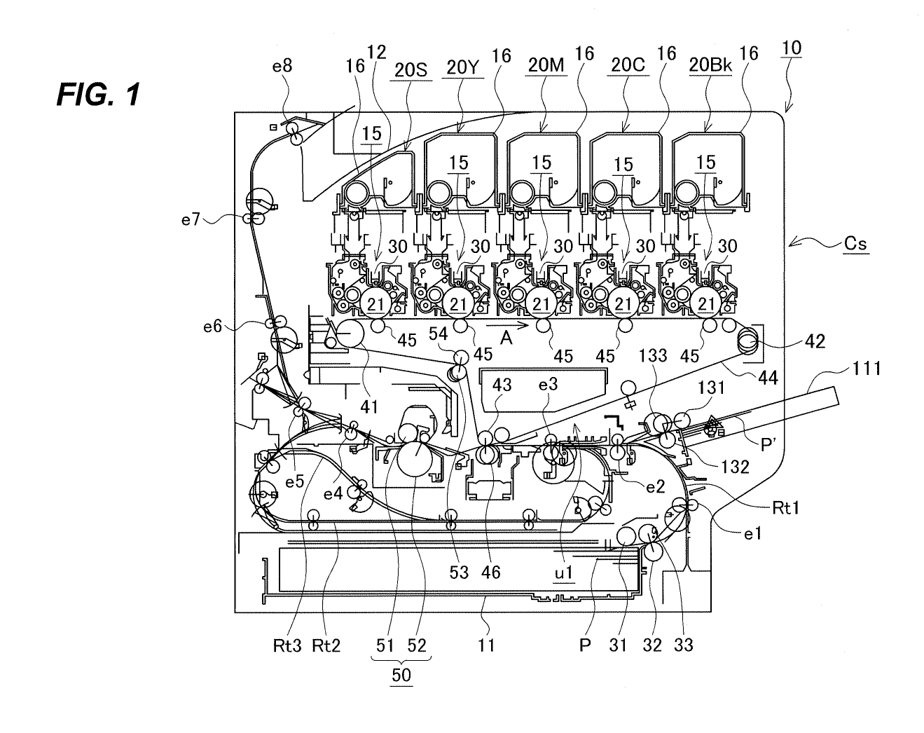

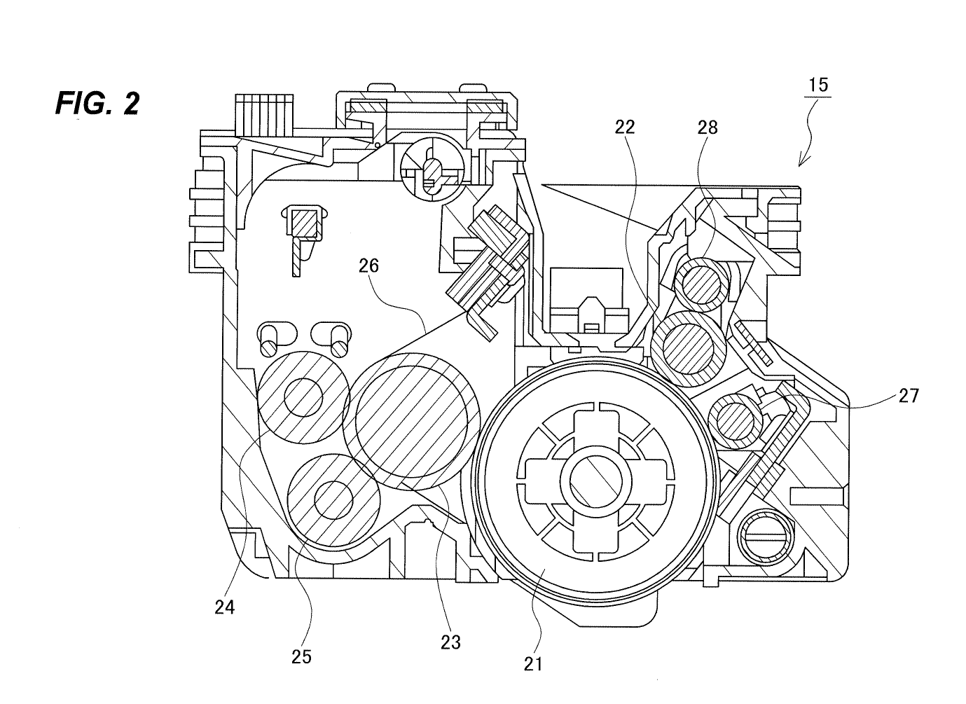

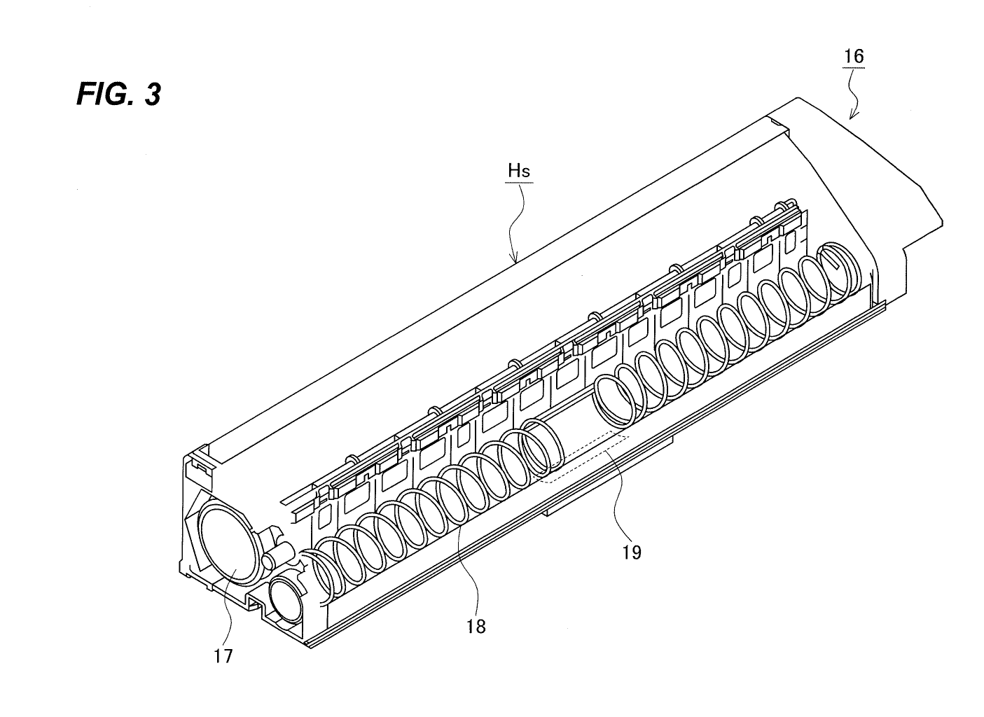

FIG. 1 is a schematic diagram of a printer 10 according to the embodiment of the present invention. FIG. 2 is a sectional view of an image forming unit according to the embodiment of the present invention. FIG. 3 is a perspective view of a toner cartridge according to the embodiment of the present invention.

As illustrated in FIG. 1, the printer 10 includes a chassis Cs. A sheet cassette 11 as a first medium storage portion is disposed at a lower portion of a main body of the printer 10 (i.e., an apparatus main body). The sheet cassette 11 stores sheets of paper P as media. A first sheet feeding mechanism is disposed adjacent to a front end of the sheet cassette 11. The first sheet feeding mechanism includes a pickup roller 31 that is rotatably disposed and rotates to pick up the sheets P from the sheet cassette 11, a feed roller 32 that rotates to feed the picked-up sheets P into a medium conveying path Rt1, and a retard roller 33 that is disposed in contact with the feed roller 32 to separate the fed sheets P one by one. The sheets P fed by the first sheet feeding mechanism are conveyed on the medium conveying path Rt1 by rotation of pairs of conveying rollers e1 to e3 as first to third conveying members disposed above the first sheet feeding mechanism.

A sheet tray 111 as a second medium storage portion is disposed at a side of the apparatus main body. Sheets of paper P′, which are, for example, sheets having sizes such that they cannot be stored in the sheet cassette 11, are placed on the sheet tray 111. A second sheet feeding mechanism is disposed adjacent to a front end of the sheet tray 111. The second sheet feeding mechanism includes a pickup roller 131 that is rotatably disposed and rotates to pick up the sheets P′ from the sheet tray 111, a feed roller 132 that rotates to feed the picked-up sheets P′ into the medium conveying path Rt1, and a retard roller 133 that is disposed in contact with the feed roller 132 to separate the fed sheets P′ one by one. The sheets P′ fed by the second sheet feeding mechanism are conveyed by the pairs of conveying rollers e2 and e3 disposed on the medium conveying path Rt1.

At an upper portion of the apparatus main body, image forming units 20S, 20Y, 20M, 20C, and 20Bk for colors of metallic color, yellow, magenta, cyan, and black are arranged from the downstream side to the upstream side in a conveying direction of the sheets P conveyed on the medium conveying path Rt1. Each of the image forming units 20S, 20Y, 20M, 20C, and 20Bk includes a photosensitive drum 21 as an image carrier. LED heads 30 as exposure devices or units are disposed above the respective photosensitive drums 21 to face the respective photosensitive drums 21. Each of the LED heads 30 illuminates a surface of the corresponding photosensitive drum 21 with light in a pattern corresponding to image data to form an electrostatic latent image as a latent image.

A transfer unit u1 is disposed below the image forming units 20S, 20Y, 20M, 20C, and 20Bk. The transfer unit u1 includes: a drive roller 41 as a first roller that is rotatably disposed under the image forming unit 20S, is connected to a belt motor (not illustrated) as a driver, and receives rotation from the belt motor to rotate; a driven roller 42 as a second roller that is rotatably disposed under the image forming unit 20Bk and rotates with rotation of the drive roller 41; a backup roller 43 as a third roller that is rotatably disposed below the drive roller 41 and driven roller 42 and rotates with rotation of the drive roller 41 and driven roller 42; a transfer belt 44 as an intermediate transfer member that is movably stretched around the drive roller 41, driven roller 42, and backup roller 43 and moves with rotation of the drive roller 41, driven roller 42, and backup roller 43 in the direction of arrow A in FIG. 1 along the image forming units 20S, 201, 20M, 200, and 20Bk; primary transfer rollers 45 as first transfer members that are disposed to respectively face the photosensitive drums 21 of the image forming units 20S, 201, 20M, 200, and 20Bk with the transfer belt 44 therebetween; a secondary transfer roller 46 as a second transfer member that is disposed to face the backup roller 43 with a sheet P and the transfer belt 44 therebetween; a reverse bending roller 53 as a reverse bending member that is rotatably disposed downstream of the backup roller 43 and upstream of the drive roller 41 in a direction in which the transfer belt 44 moves, is pressed against an outer surface of the transfer belt 44, and rotates with movement of the transfer belt 44; a backup roller 54 that is disposed to face the reverse bending roller 53 with the transfer belt 44 therebetween and rotates with movement of the transfer belt 44; and the like.

The image forming units 20S, 20Y, 20M, 200, and 20Bk are arranged from the upstream side to the downstream side in the movement direction of the transfer belt 44, the image forming unit 20S being disposed most upstream, the image forming unit 20Bk being disposed most downstream.

The primary transfer rollers 45 sequentially transfer (or primary-transfer) toner images as developer images of the respective colors formed on the respective photosensitive drums 21 onto the transfer belt 44 in a superposed manner, thereby forming a color toner image on the transfer belt 44. Each of the primary transfer rollers 45 is urged toward the corresponding photosensitive drum 21 and forms a primary transfer portion between the primary transfer roller 45 and the corresponding photosensitive drum 21.

The secondary transfer roller 46 transfers (or secondary-transfers) the color toner image formed on the transfer belt 44 onto a sheet P, thereby forming a color toner image on the sheet P. The secondary transfer roller 46 is urged toward the backup roller 43 and forms a secondary transfer portion between the secondary transfer roller 46 and the backup roller 43.

The reverse bending roller 53 and backup roller 54 are disposed to prevent displacement of an image when the image is formed on a sheet P.

A fixing unit 50 as a fixing device is disposed downstream of the secondary transfer portion in the medium conveying path Rt1. The fixing unit 50 includes a heating roller 51 as a first fixing member rotatably disposed and including a heater (not illustrated), such as a halogen lamp, as a heat source, and a pressure roller 52 as a second fixing member rotatably disposed in contact with the heating roller 51. The fixing unit 50 heats and presses the color toner image on the sheet P conveyed from the secondary transfer portion to fix the color toner image to the sheet P, thereby forming a color image. In the color image, the toner image of metallic color, which is a special color, is located uppermost among the toner images of the respective colors formed on the sheet P.

Pairs of conveying rollers e4 to e7 as fourth to seventh conveying members are disposed downstream of the fixing unit 50 in the medium conveying path Rt1, and a pair of discharging rollers e8 as a discharging member is disposed downstream of the pair of conveying rollers e7. The sheet P with the color image formed thereon is conveyed by the pairs of conveying rollers e4 to e7, and then discharged and loaded by the pair of discharging rollers e8 onto a stacker 12 as a medium placement portion formed outside the apparatus main body.

The printer 10 has a duplex printing function of forming images on both sides of a sheet P. When images are formed on both sides of a sheet P, after a toner image is fixed to a front side of the sheet P in the fixing unit 50, the sheet P is conveyed from the medium conveying path Rt1 to an escape conveying path Rt2 between the pairs of conveying rollers e4 and e5, and conveyed from the escape conveying path Rt2 to an inverting conveying path Rt3. At this time, the sheet P is inverted. Then, the sheet P passes above the sheet cassette 11, is conveyed to the medium conveying path Rt1 between the pairs of conveying rollers e2 and e3, is subjected to transferring of a toner image onto a back side of the sheet P at the secondary transfer portion, and is subjected to fixation of the toner image to the back side by the fixing unit 50.

The image forming units 20S, 20Y, 20M, 20C, and 20Bk will now be described.

Each of the image forming units 20S, 20Y, 20M, 20C, and 20Bk includes a unit main body 15 that is a main body of the image forming unit, and a toner cartridge 16 as a developer container that is removably attached to the unit main body 15 and stores toner as developer. The toner cartridges 16 of the image forming units 20S, 20Y, 20M, 20C, and 20Bk store toners of metallic color, yellow, magenta, cyan, and black, respectively. As the metallic color toner, a brilliant toner (or a toner containing a brilliant pigment) having metallic luster, such as gold and silver, is used. As the yellow, cyan, magenta, and black toners, toners containing organic pigments, such as pigment yellow, pigment cyan, pigment magenta, and carbon black, are used. In this embodiment, the toners are used as one-component developers. However, the toners may be used as two-component developers together with carriers.

Each of the unit main bodies 15 includes: a charging roller 22 as a charging device that is rotatably disposed in contact with the photosensitive drum 21, rotates with rotation of the photosensitive drum 21, and uniformly charges a surface of the photosensitive drum 21; a developing roller 23 as a developer carrier that is rotatably disposed in contact with the photosensitive drum 21 and develops an electrostatic latent image to form a toner image; toner supplying rollers 24 and 25 as first and second developer supplying members that supply the developing roller 23 with toner supplied from the toner cartridge 16; a developing blade 26 as a developer layer regulating member that forms toner on the developing roller 23 into a thin layer to form a toner layer as a developer layer; a cleaning roller 27 as a first cleaning member that scrapes off and removes residual toner on the photosensitive drum 21 after the primary transfer to clean the photosensitive drum 21; a cleaning roller 28 as a second cleaning member that removes toner adhering to the charging roller 22; and the like.

Each of the toner cartridges 16 includes: a case Hs in which a toner chamber is formed; a shutter 17 rotatably disposed in the toner chamber in the case Hs; a lever (not illustrated) disposed at an end of the toner cartridge 16; and a spiral 18 as an agitator rotatably disposed in the case Hs. When the shutter 17 is rotated by means of the lever, the toner in the toner chamber is discharged from a toner supply port 19 as a developer supply port formed at a center of a lower end portion of the case Hs and supplied to the unit main body 15. When the spiral 18 is rotated, the toner in the toner chamber is agitated, moved from both end portions to a central portion of the toner chamber, and discharged from the toner supply port 19.

The operation of the printer 10 will now be described.

A sheet P is fed by the first sheet feeding mechanism from the sheet cassette 11 into the medium conveying path Rt1, conveyed by the pairs of conveying rollers e1 to e3 to the secondary transfer portion.

In each of the image forming units 20S, 20Y, 20M, 20C, and 208k, the charging roller 23 uniformly charges the surface of the photosensitive drum 21, and the LED head 30 illuminates the surface of the photosensitive drum 21 with light having a pattern corresponding to image data to form an electrostatic latent image.

Toner supplied from the toner cartridge 16 and held by the toner supplying rollers 24 and 25 is supplied to the developing roller 23. When the developing roller 23 comes into contact with a portion on the surface of the photosensitive drum 21 where the electrostatic latent image is formed, the toner supplied to the developing roller 23 adheres to the photosensitive drum 21 due to a potential difference between the electrostatic latent image on the photosensitive drum 21 and the developing roller 23, thereby forming a toner image on the photosensitive drum 21.

In the transfer unit u1, while the transfer belt 44 is moved, the primary transfer rollers 45 sequentially transfer the toner images of the respective colors onto the transfer belt 44 at the primary transfer portions in a superposed manner to form a color toner image on the transfer belt 44, and the secondary transfer roller 46 transfers the color toner image onto the sheet P at the secondary transfer portion to form a color toner image on the sheet P.

Then, the sheet P is conveyed to the fixing unit 50, which heats and presses the color toner image to fix it to the sheet P, so that a color image is formed on the sheet P. The sheet P with the color image formed thereon is conveyed by the pairs of discharging rollers e4 to e7, discharged by the pair of discharging rollers e8 out of the apparatus main body, and loaded on the stacker 12.

In this embodiment, aluminum is used as the brilliant pigment (i.e., pigment with brilliance) contained in the brilliant toner, and aluminum flakes are included in toner base particles (or mother particles) of the toner. Depending on the content of aluminum in the brilliant toner, the quality of color images formed by the printer 10 may be low.

Specifically, since aluminum is a metal material having high conductivity, the aluminum flakes facilitate escape of charges from the toner when the toner is charged, and may prevent the toner from being charged sufficiently. If the average particle size of the aluminum flakes is large, it is difficult to include or enclose the aluminum flakes in the toner base particles, and some aluminum flakes may be exposed. This further facilitates escape of charges from the toner, leading to insufficient charge of the toner.

When the charge amount of the toner is small, a toner image on the photosensitive drum 21 cannot be properly transferred onto a sheet P, leading to low image quality.

So it is conceivable to reduce the content of aluminum in the toner. However, this reduces image brilliance and degrades image quality. It is also conceivable to reduce the average particle size of the brilliant pigment. However, this reduces the brilliance of the toner and degrades image quality.

In this embodiment, various brilliant toners produced by a dissolution suspension method are used.

An experiment was carried out to evaluate whether image quality can be improved by using a brilliant toner produced by the dissolution suspension method. The experiment will be described below.

In this experiment, various brilliant toners each containing a brilliant pigment (or brilliant pigment particles) were produced. The average particle size of the brilliant pigment (or brilliant pigment particles) of each of the brilliant toners was greater than or equal to 5 μm and less than or equal to 20 μm.

The average particle size of the brilliant pigment of each of the brilliant toners was measured by using a digital microscope (VH-5500, manufactured by Keyence Corporation) and a lens (VH-500, manufactured by Keyence Corporation) as follows. The brilliant toner was dispersed in a surface activating agent (EMULGEN 109P, manufactured by Kao Corporation). The resulting liquid was dropped on a slide glass, covered by a cover glass, and observed with the digital microscope at a magnification of 1000 times using transmission illumination. By taking advantage of the fact that the brilliant pigment particles constituting the brilliant pigment block light and look black, longitudinal sizes (or dimensions) of 50 brilliant pigment particles contained in the brilliant toner were measured, and an average of the measured sizes was obtained as the average particle size.

When the average particle size of the brilliant pigment of a toner is less than 5 μm, the brilliance of the toner is low, leading to low image brilliance and low image quality. On the other hand, when the average particle size of a brilliant pigment is greater than 20 μm, it is difficult to include or enclose the brilliant pigment in toner base particles, and it is difficult to form a toner. Even if a toner can be formed using such a brilliant pigment, it is difficult to convey the toner in the printer, and it is difficult to properly form an image.

### EXAMPLES

The methods of producing the brilliant toners will now be described.

### Example 1

First, 738 parts by weight of industrial trisodium phosphate dodecahydrate was added to 21200 parts by weight of pure water, and dissolved therein at a liquid temperature of 60° C. Then, the resulting liquid was added with dilute nitric acid for pH adjustment. The resulting solution was added with a calcium chloride solution obtained by adding and dissolving 356 parts by weight of industrial calcium chloride anhydride in 3617 parts by weight of pure water, and was stirred with a Line Mill (manufactured by Primix Corporation) at a speed of 3566 revolutions per minute (rpm) for 34 minutes while being maintained at a liquid temperature of 60° C. In this manner, an aqueous phase that is an aqueous medium with a suspension stabilizer (inorganic dispersant) dispersed therein was prepared.

Further, a pigment dispersion liquid was prepared by mixing 252 parts by weight of brilliant pigment A (having an average particle size of 5 μm and a hydrophobicity degree of 80) and 38 parts by weight of a charge control agent (BONTRON E-84, manufactured by Orient Chemical Industries Co., Ltd.) with 7546 parts by weight of ethyl acetate. Then, the pigment dispersion liquid was stirred while being maintained at a liquid temperature of 50° C., and added with 38 parts by weight of a charge control resin (FCA-726N, manufactured by Fujikura Kasei Co., Ltd.), 95 parts by weight of an ester wax (WE-4, manufactured by NOF Corporation) as a release agent, and 838 parts by weight of polyester resin as a binder resin. The stirring was continued until solid dissolved. In this manner, an oil phase that is a pigment dispersion oil medium was prepared.

Then, the oil phase was added to the aqueous phase maintained at a temperature of 60° C., and suspended by stirring at a speed of 1000 rpm for 5 minutes, so that particles were formed in a suspension liquid.

Next, the ethyl acetate was removed by distilling the suspension liquid under reduced pressure, so that a slurry containing the particles was formed. The slurry was added with nitric acid so that the pH of the slurry was adjusted to 1.6 or lower, and was stirred. Tricalcium phosphate as a suspension stabilizer was dissolved therein, and toner particles were obtained through dehydration.

Then, the toner particles were re-dispersed in pure water and stirred to be water-washed. After that, through dehydration, drying, and classification processes, toner base particles were obtained. The classification process was performed so that the percentage of the number of toner base particles having particle sizes not greater than 10 μm, which are rich in resin, relative to the total number of the toner base particles was 62%.

Then, in an external addition process, 100 parts by weight of the toner base particles thus obtained were added and mixed with 0.7 parts by weight of small silica (AEROSIL RY200, manufactured by Nippon Aerosil Co., Ltd.) and 1.0 parts by weight of colloidal silica (X-24-9163A, manufactured by Shin-Etsu Chemical Co., Ltd.) as external additives, so that toner A was prepared.

### Example 2

Toner B was prepared in the same manner as in Example 1 except that the amount of brilliant pigment A was changed to 188 parts by weight.

### Example 3

Toner C was prepared in the same manner as in Example 1 except that the amount of brilliant pigment A was changed to 126 parts by weight.

### Example 4

Toner D was prepared in the same manner as in Example 1 except that the classification process was performed so that the percentage of the number of toner base particles having particle sizes not greater than 10 μm, which are rich in resin, relative to the total number of the toner base particles was 72%.

### Example 5

Toner E was prepared in the same manner as in Example 1 except that brilliant pigment B (having an average particle size of 20 μm and a hydrophobicity degree of 80) was used instead of brilliant pigment A.

### Example 6

Toner F was prepared in the same manner as in Example 5 except that the classification process was performed so that the percentage of the number of toner base particles having particle sizes not greater than 10 μm, which are rich in resin, relative to the total number of the toner base particles was 65%.

### Comparative Example 1

Toner G was prepared in the same manner as in Example 1 except that the amount of brilliant pigment A was changed to 63 parts by weight.

### Comparative Example 2

Toner H was prepared in the same manner as in Example 1 except that brilliant pigment C (having an average particle size of 5 μm and a hydrophobicity degree of 60) was used instead of brilliant pigment A.

### Comparative Example 3

Toner I was prepared in the same manner as in Example 1 except that brilliant pigment D (having an average particle size of 5 μm and a hydrophobicity degree of 40) was used instead of brilliant pigment A.

### Comparative Example 4

Toner J was prepared in the same manner as in Example 1 except that the classification process was performed so that the percentage of the number of toner base particles having particle sizes not greater than 10 μm, which are rich in resin, relative to the total number of the toner base particles was 56%.

For each of toners A to J thus prepared, the content of aluminum in the toner (i.e., the amount of aluminum contained in the toner) was measured.

In general, the amount of a pigment contained in a toner is often defined by the amount of the pigment used (or added) in production of the toner. However, not all the pigment used in production of the toner is incorporated into the toner, and some of the pigment is incorporated into toner particles that are not collected in the classification process. Thus, it is not appropriate to define the amount of the pigment contained in the toner by using the used amount.

Further, the proportion of the pigment relative to the pigment dispersion liquid prepared by mixing ethyl acetate, the pigment, and the charge control agent is different from the proportion of the pigment relative to the toner base particles. Thus, it is difficult to define the amount of the pigment contained in the toner by using the used amount.

Thus, for each of toners A to J prepared as described above, the amount of aluminum contained in the toner was measured using an energy dispersive X-ray fluorescence spectrometer (EDX-800HS, manufactured by Shimadzu Corporation).

When a sample is irradiated with X-rays, the sample generates and emits fluorescent X-rays that are X-rays unique to atoms contained in the sample. The fluorescent X-rays have a wavelength (or energy) characteristic of each element. Thus, qualitative analysis can be performed by investigating the wavelengths of the fluorescent X-rays. Further, since the fluorescent X-ray intensity is a function of the concentration, quantitative analysis can be performed by measuring the amount of X-rays at the wavelength specific to each element.

Thus, for each of toners A to J, by using the energy dispersive X-ray fluorescence spectrometer, X-rays were radiated from an X-ray tube to the toner, and the content of aluminum in the toner was measured on the basis of fluorescent X-rays emitted from aluminum atoms contained in the toner. At this time, the content of aluminum in the toner was represented by the volume percentage of aluminum relative to the toner (or the percentage of the volume of aluminum contained in the toner relative to the total volume of the toner).

The energy dispersive X-ray fluorescence spectrometer was used under the following conditions:

Atmosphere: Helium purge measurement

X-ray irradiation conditions:
Voltage: 15 kV
Current: 100 μA

For each of toners A to J, a solid image was formed using only the metallic color toner. The solid image was formed on a sheet P at a printing duty of 100% using a five-color printer (C941, manufactured by OKI Data Corporation) (see FIG. 1) in which the toner was stored in the toner cartridge 16 of the image forming unit 20S, in a special color clear mode of the printer. At this time, the printing conditions were set so that the amount of the toner adhering to the photosensitive drum 21 of the image forming unit 20S was 1.2 mg/cm².

Then, for each of toners A to J, the quality of the image thus formed on the sheet P was evaluated by measuring the brilliance of the image using a goniophotometer (GC-5000L, manufactured by Nippon Denshoku Industries Co., Ltd.).

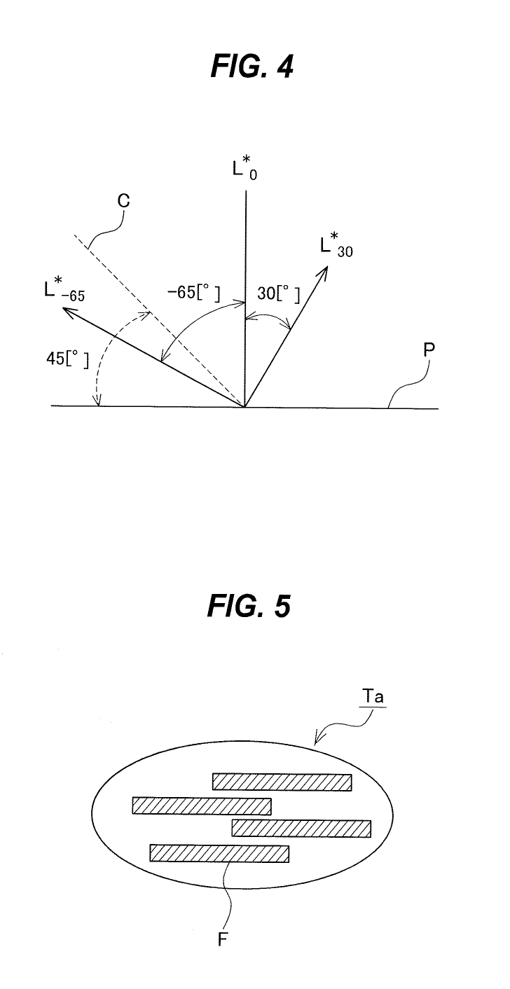

FIG. 4 is a diagram for explaining a method of measuring the brilliance of a solid image in the embodiment of the present invention.

FIG. 4 shows a sheet P on which an image is formed, and a light ray C emitted by the goniophotometer.

The brilliance of the image formed on the sheet P can be represented by a flop index FI given by the following equation (1):

FI=2.69×(L*₃₀−L*₋₆₅)^{1.11}/(L*₀)^{0.86}. (1)

Specifically, for each of toners A to J, the brilliance of the image was measured by calculating the flop index FI as follows. By means of the goniophotometer, the sheet P was irradiated with the light ray C at an angle of 45° relative to a surface of the sheet P; the light reflected by the sheet P was received at an angle of 0° relative to a direction perpendicular to the surface of the sheet P and thereby a lightness index L*₀ was calculated; the light reflected by the sheet P was received at an angle of 30° relative to the direction perpendicular to the surface of the sheet P and thereby a lightness index L*₃₀ was calculated; the light reflected by the sheet P was received at an angle of −65° relative to the direction perpendicular to the surface of the sheet P and thereby a lightness index L*₋₆₅ was calculated; the flop index FI was calculated by substituting the calculated lightness indexes L*₀, L*₃₀, and L*₋₆₅ into equation (1).

In this case, as the flop index FI is higher, the brilliance is higher, and as the flop index FI is lower, the brilliance is lower. In this embodiment, when the flop index FI was greater than or equal to 14, printed products had metallic luster, and thus it was determined that the brilliance of the image was high. When the flop index FI was less than 14, printed products had no metallic luster, and thus it was determined that the brilliance of the image was low.

Further, for each of toners A to J, the image quality was evaluated by calculating a transfer efficiency when a toner image was transferred onto a sheet P using the toner in the following manner.

A solid image was formed using only the metallic color toner at a printing duty of 100%, using the image forming unit 20S storing the toner in the toner cartridge 16. The toner image was transferred onto the transfer belt 44 and further transferred onto a sheet P, so that a metallic color image was formed on the sheet P. At this time, the printing conditions were set so that the amount Md of the toner adhering to the photosensitive drum 21 of the image forming unit 20S was 1.2 mg/cm².

Then, the amount Mp of the toner transferred onto the sheet P was measured, and the transfer efficiency r of the toner image was calculated by the following equation:

η=(Mp/Md)×100 (%).

Each of the adhering toner amounts Md and Mp was measured as follows. A double-sided adhesive tape having an area of 1 cm² was attached to a tip of a jig. While the tip of the jig was applied with a voltage of +300 V, the double-sided adhesive tape was pressed against the photosensitive drum 21 or sheet P. Then, the weight of toner adhering to the double-sided adhesive tape was measured as the adhering toner amount Md or Mp.

When the transfer efficiency η is higher than or equal to 25%, the amount Mp of the toner adhering to the sheet P is large, the flop index FI is greater than or equal to 14, and the brilliance is high.

On the other hand, the transfer efficiency η is lower than 25%, the amount Mp of the toner adhering to the sheet P is small, the flop index FI is less than 14, and the brilliance is low. When the transfer efficiency η is low, the consumption of toner is large, and the amount of waste toner, which is toner that is not transferred as a toner image and discarded, is large. This may cause clogging of a transporting path of the waste toner in the image forming unit 20S.

Next, an inclusion degree of a brilliant pigment (or brilliant pigment particles) in toner base particles will be described.

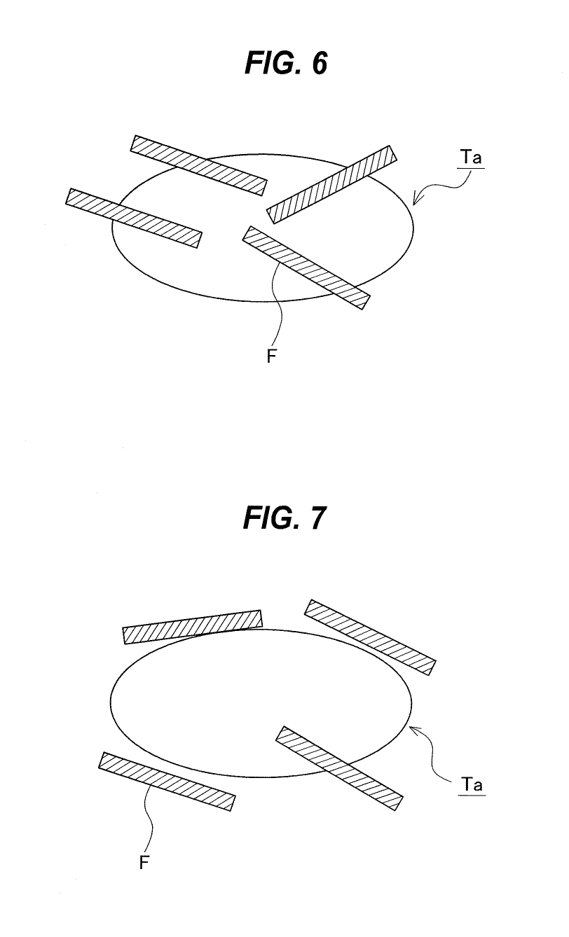

FIGS. 5 to 7 are diagrams each for explaining the inclusion degree of a pigment in the embodiment of the present invention.

FIGS. 5 to 7 each illustrate a toner base particle Ta and brilliant pigment particles F. In FIG. 5, the pigment particles F are completely included in the toner base particle Ta, and the inclusion degree is high. In FIG. 6, part of the pigment particles F is not included in the toner base particle Ta, and the inclusion degree is somewhat low. In FIG. 7, most part of the pigment particles F is not included in the toner base particle Ta, and the inclusion degree is extremely low.

For each of toners A to J, the inclusion degree of the brilliant pigment particles in the toner base particles was determined as follows. First, 1 g of the toner and 19 g of a carrier (N-01, provided by The Imaging Society of Japan) were lightly mixed together in a container. The resulting mixture was left for 24 hours or more under an environment at a temperature of 23° C. and a relative humidity of 50%, and then was shaken by a shaker (YS-8D, manufactured by YAYOI Co., Ltd.) at a speed of 2 reciprocations per second, so that charge of the toner was saturated. Then, a 0.2 g sample of the mixture of the toner and carrier was taken out from the container, and a charge amount Q, which is a blow-off charge amount (or saturated charge amount) per unit weight, of the toner was measured using a Q/M meter (210HS-2A, manufactured by Trek Japan Co., Ltd.). In the toner, aluminum is used as the brilliant pigment. For this reason, when the inclusion degree of the brilliant pigment in the toner base particles is low, charges easily escape from the toner when the toner is charged, and the toner cannot be charged sufficiently. Thus, when the charge amount Q of the toner is large, it can be determined that the inclusion degree of the brilliant pigment in the toner base particles is high. When the charge amount Q of the toner is small, it can be determined that the inclusion degree of the brilliant pigment in the toner base particles is low.

In this embodiment, for each of toners A to J, the inclusion degree was determined as follows. When the charge amount Q of the toner was greater than or equal to 10 (−μC/g) (or less than or equal to −10 μC/g), that is, when the absolute value of the saturated charge amount Q of the toner was greater than or equal to 10 μC/g, it was determined that the inclusion degree of the brilliant pigment in the toner base particles was high. In this case, charges do not easily escape from the toner when the toner is charged, and an image with high brilliance can be formed on a sheet P. On the other hand, when the charge amount Q of the toner is less than 10 (−μC/g) (or greater than −10 μC/g), that is, when the absolute value of the saturated charge amount Q of the toner was less than 10 μC/g, it was determined that the inclusion degree of the brilliant pigment in the toner base particles was low. In this case, charges easily escape from the toner when the toner is charged, and it is difficult to form an image with high brilliance on a sheet P.

Each of toners A to J was evaluated on the basis of the content of aluminum, the charge amount Q, the brilliance based on the calculated value of the flop index FI, the transfer efficiency η, and the inclusion degree of the brilliant pigment in the toner base particles. The results of the evaluation of toners A to J will now be described.

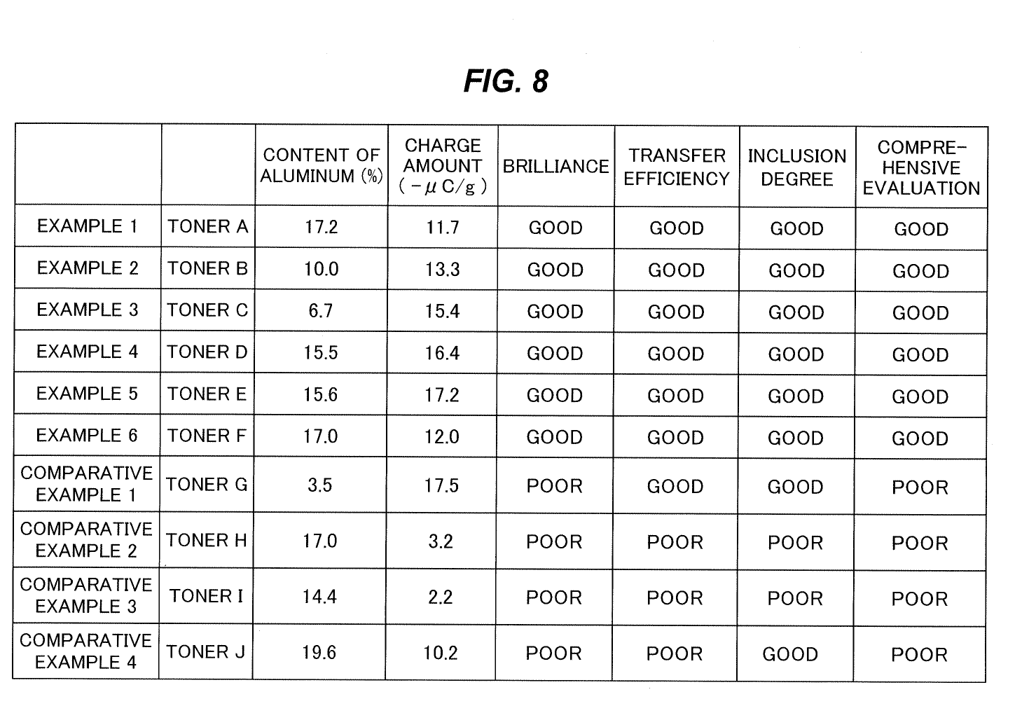

FIG. 8 is a table showing the evaluation results of the toners in the embodiment of the present invention.

For each of toners A to J, FIG. 8 shows the content of aluminum, the charge amount Q, the evaluation of the brilliance based on the calculated value of the flop index FI, the evaluation of the transfer efficiency η, the evaluation of the inclusion degree of the brilliant pigment in the toner base particles, and the comprehensive evaluation of the toner. The brilliance, transfer efficiency, and the inclusion degree were evaluated as “good” or “poor”. The toner was comprehensively evaluated as “good” or “poor”. In each of toners A to J, the average particle size of the brilliant pigment was greater than or equal to 5 μm and less than or equal to 20 μm.

In this embodiment, when the content of aluminum was greater than or equal to 6.7% and less than or equal to 17.2%, the flop index FI was greater than or equal to 14, the image brilliance was high, and the image quality was good. The content of aluminum is preferably greater than or equal to 10.0% and less than or equal to 17.2%, and more preferably greater than or equal to 15.6% and less than or equal to 17.2%. In these ranges, FI was greater, and the image brilliance was higher.

When the content of aluminum is less than 6.7%, the amount Mp of the transferred toner adhering to the sheet P is greater than or equal to 0.3 mg/cm², the transfer efficiency η of the toner image is greater than or equal to 25% (=0.3/1.2×100%), and the transfer efficiency η is high. However, since the content of the brilliant pigment in the toner is small, the image brilliance is low. On the other hand, when the content of aluminum is greater than 17.2%, the amount of aluminum contained in the toner base particles is large, charges easily escape from the toner when the toner is charged, and the transfer efficiency η is low. As a result, the adhering amount Mp of the toner on the sheet P is small, and the image brilliance is low.

Further, even when the content of aluminum is greater than or equal to 6.7% and less than or equal to 17.2%, if the aluminum flakes are not adequately included in the toner base particles, charges easily escape from the toner when the toner is charged, and the transfer efficiency η is low.

Thus, it is preferable that the content of aluminum be greater than or equal to 6.7% and less than or equal to 17.2%, and the charge amount Q of the toner be greater than or equal to 10 (−μC/g) (or less than or equal to −10 μC/g), or the absolute value of the saturated charge amount Q be greater than or equal to 10 μC/g.

In the above embodiment, the printer 10 has been described, but the present invention is applicable to other image forming apparatuses, such as copiers, facsimile machines, or multi-function peripherals (MFPs).

The present invention is not limited to the embodiment described above; it can be practiced in various other aspects without departing from the invention scope.

What is claimed is:

1. A toner comprising:
a binder resin;
a release agent; and
a brilliant pigment comprising aluminum,
wherein a content of aluminum in the toner is greater than or equal to 6.7% and less than or equal to 17.2%, the content of aluminum being measured by an energy dispersive X-ray fluorescence spectrometer.

2. The toner of claim 1, wherein the content of aluminum is greater than or equal to 10.0% and less than or equal to 17.2%.

3. The toner of claim 2, wherein the content of aluminum is greater than or equal to 15.6% and less than or equal to 17.2%.

4. The toner of claim 1, wherein an absolute value of a saturated charge amount of the toner is greater than or equal to 10 μC/g.

5. The toner of claim 1, wherein an average particle size of the brilliant pigment is greater than or equal to 5 μm and less than or equal to 20 μm.

6. The toner of claim 1, wherein when the toner is supplied onto an image carrier and transferred from the image carrier onto a medium, a transfer efficiency of the toner is greater than or equal to 25%, the transfer efficiency being a percentage of an amount of the toner supplied onto the image carrier to an amount of the toner transferred onto the medium.

7. A developer container that stores the toner of claim 1.

8. An image forming unit comprising the developer container of claim 7.

9. An image forming unit that stores the toner of claim 1.

10. An image forming apparatus comprising the image forming unit of claim 8.

11. An image forming apparatus comprising the image forming unit of claim 9.
